(19) United States
(12) Patent Application Publication
(10) Pub. No.: US 2006/0171644 A1
(43) Pub. Date: Aug. 3, 2006

(54) Optical fiber cable

(75) Inventors: Takahiro Sato, Hitachi (JP); Tatsuo Teraoka, Hitachi (JP); Yoshihiro Kodaka, Kitaibaraki (JP)

Correspondence Address: MCGINN INTELLECTUAL PROPERTY LAW GROUP, PLLC, 8321 OLD COURTHOUSE ROAD, SUITE 200, VIENNA, VA, 22182-3817, US

(73) Assignee: Hitachi Cable, Ltd., Tokyo (JP)

(21) Appl. No.: 11/300,412

(22) Filed: Dec. 15, 2005

(30) Foreign Application Priority Data
Jan. 28, 2005 (JP) 2005-021246

(51) Int. Cl. G02B 6/44

(52) U.S. Cl. 385/114

(57) ABSTRACT

An optical fiber cable comprises optical fiber tapes, each of which is composed of a plurality of optical fiber cores disposed in parallel and connected by a joint member, and two or more pieces of the optical fiber tapes are layered and accommodated in a sheath. The optical fiber tape is provided with a concave portion between adjacent optical fiber cores and a convex portion, and the two or more pieces of the optical fiber tapes are layered by engaging the concave portion and convex portion to be accommodated in the sheath.

The present application is based on Japanese Patent Application No. 2005-021246 filed on Jan. 28, 2005, the entire contents of which are incorporated herein by reference.

### BACKGROUND OF THE INVENTION

Field of the Invention

The present invention relates to optical fiber cable for installation, which is installed in an underground conduit or between ground electric poles and is drawn into a building, a condominium, or a house from the electric pole, in more particularly, to an optical fiber cable, in which layered optical fiber tapes are accommodated in a sheath.

In recent years, an -optical fiber cable using an optical fiber tape is used for the layout drawn into subscriber's residence such as building, individual house, so as to realize a FTTH (Fiber to The Home), namely a communication of ultrahigh speed and large capacity for respective homes or offices.

FIG. 1 shows a configuration of a conventional optical fiber cable, which is disclosed by Japanese Patent Laid-Open No. 2003-295011 (JP-A-2003-295011). In an optical fiber cable 100 shown in FIG. 1, a pair of tensile strength resistant members 121 comprising a conductive metal wire or a non-conductive metal wire such as glass fiber, plastic, etc. are provided along both sides of two pieces of optical fiber tapes 112 that are layered. An optical element part 118 comprises a pair of the optical fiber tapes 112 and the tensile strength resistant members 121 covered collectively with a sheath 120 made of a thermoplastic resin such as fire-resistant PE. In addition, a supporting wire part 119 comprises a supporting wire 126 made of a metal wire, e.g. a steel wire, and a supporting wire part sheath 123 made of a thermoplastic resin such as PVC, fire-resistant PE for covering the supporting wire 126. The optical element part 118 and supporting wire part 119 are connected in parallel with each other by a constricted neck portion 122. Further, a notch 124 for tearing up the optical fiber cable 100 is provided on both of long side faces of the sheath 120 to take out the optical fiber tapes 112. Further, another conventional optical fiber having a similar configuration is disclosed by Japanese Patent Laid-Open No. 2004-061649 (JP-A-2004-061649).

However, when a stress occurs in a direction along side surfaces of the long side of the sheath 120 in the optical fiber cable 100 shown in FIG. 1, there is a disadvantage in that small curves are produced in the optical fiber tapes 112, thereby increasing an optical loss of the optical fiber.

### SUMMARY OF THE INVENTION

Accordingly, for solving the above problem, it is an object of the present invention to provide an optical fiber cable in which the increase of an optical loss in the optical fiber can be suppressed even if a stress is generated.

According to a feature of the present invention, an optical fiber cable, comprises:

an optical fiber tape comprising a plurality of optical fiber cores disposed in parallel and a joint member for connecting a plurality of the optical fiber cores; and

a sheath for accommodating two or more pieces of the optical fiber tapes;

wherein the optical fiber tape is provided with a concave portion between adjacent optical fiber cores and a convex portion, and the two or more pieces of the optical fiber tapes are layered by engaging the concave portion and convex portion.

According to a second feature of the invention, the optical fiber core- may comprise an optical fiber colored strand having a colored layer as an outermost layer, and an over coating- layer formed on the optical fiber colored strand to have an outer diameter of 0.4 mm or more.

According to a third feature of the invention, it is preferable that one or two tensile strength resistant members is accommodated in the sheath.

According to a fourth feature of the invention, an optical fiber cable, comprises:

an optical fiber tape comprising a plurality of optical fiber cores disposed in parallel and a joint member for connecting a plurality of the optical fiber cores;

a sheath for accommodating two or more pieces of the optical fiber tapes; and

a supporting wire part comprises a supporting wire and a supporting wire part sheath provided on an outer periphery of the supporting wire, and the supporting wire part is connected to the sheath via a neck portion continuously;

wherein the optical fiber tape is provided with a concave portion between adjacent optical fiber cores and a convex portion, and the two or more pieces of the optical fiber tapes are layered by engaging the concave portion and convex portion.

it is preferable that a supporting wire part comprises a supporting wire and a supporting wire part sheath provided on an outer periphery of the supporting wire, and the supporting wire part is connected to the sheath via a neck portion continuously.

According to a fifth feature of the invention, an optical fiber cable, comprises:

an optical fiber tape comprising a plurality of optical fiber cores disposed in parallel and a joint member for connecting a plurality of the optical fiber cores;

a sheath for accommodating two or more pieces of the optical fiber tapes; and

a supporting wire part comprises a supporting wire and a supporting wire part sheath provided on an outer periphery of the supporting wire, and the supporting wire part is connected to the sheath via a neck portion intermittently;

wherein the optical fiber tape is provided with a concave portion between adjacent optical fiber cores and a convex portion, and the two or more pieces of the optical fiber tapes are layered by engaging the concave portion and convex portion.

According to the present invention, it is possible to provide an effect that the increase of the optical loss in the optical fiber can be suppressed and that a lateral pressure resistance characteristics is excellent, in case where a stress occurs in a direction along side surfaces of a long side of a sheath in an optical fiber cable.

### BRIEF DESCRIPTION OF THE DRAWINGS

Next, preferred embodiment according to the present invention will be explained in conjunction with appended drawings, wherein:

FIG. 1 is a cross sectional view showing a conventional optical fiber cable;

FIG. 2 is a cross sectional view showing an optical fiber cable in a preferred embodiment according to the present invention;

FIG. 3 is a cross sectional view showing an optical fiber tape used for the optical fiber cable in the preferred embodiment according to the present invention;

FIG. 4 is a cross sectional view showing an optical fiber core used for the optical fiber cable in the preferred embodiment according to the present invention;

FIGS. 5A and 5B are diagrams showing side views of the optical fiber cable in the preferred embodiment according to the present invention, wherein FIG. 5A is a side view of the optical fiber in which neck portion is provided continuously and FIG. 5B is a side view of the optical fiber in which neck portion is provided intermittently;

FIG. 6 is a schematic diagram showing a method of conducting a lateral pressure characteristic evaluation test; and

FIG. 7 is a graph showing a result of the lateral pressure characteristic evaluation test.

### DESCRIPTION OF THE PREFERRED EMBODIMENTS

Next, the preferred embodiment according to the present invention will be explained in conjunction with the appended drawings.

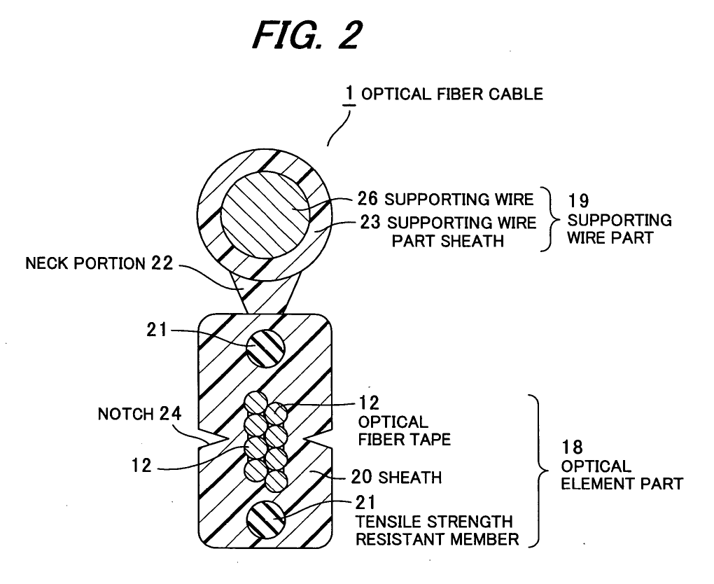

FIG. 2 shows an optical fiber cable in a preferred embodiment according to the present invention.

An optical fiber cable 1 in the preferred embodiment shown in FIG. 2 is an optical fiber cable having a substantially rectangular cross section. An optical fiber cable 1 comprises an optical element part 18 and a supporting wire part 19.

In the optical element part 18, two pieces of optical fiber tapes 12 are layered by engaging concave portions 29 and convex portions 28, and tensile strength resistant members 21 are disposed on both sides of the layered optical fiber tapes 12. The optical fiber tapes 12 and tensile strength resistant members 21 are covered with a sheath 20 collectively to be accommodated in the sheath 20.

In the supporting wire part 19, a supporting wire part sheath 23 is provided on an outer periphery of a supporting wire 26.

The optical element part 18 and supporting wire part 19 are connected in parallel with each other by a constricted neck portion 22. Further, a notch 24 for tearing up the optical fiber cable 1 is provided on both of long side faces of the sheath 20 to take out the optical fiber tapes 12.

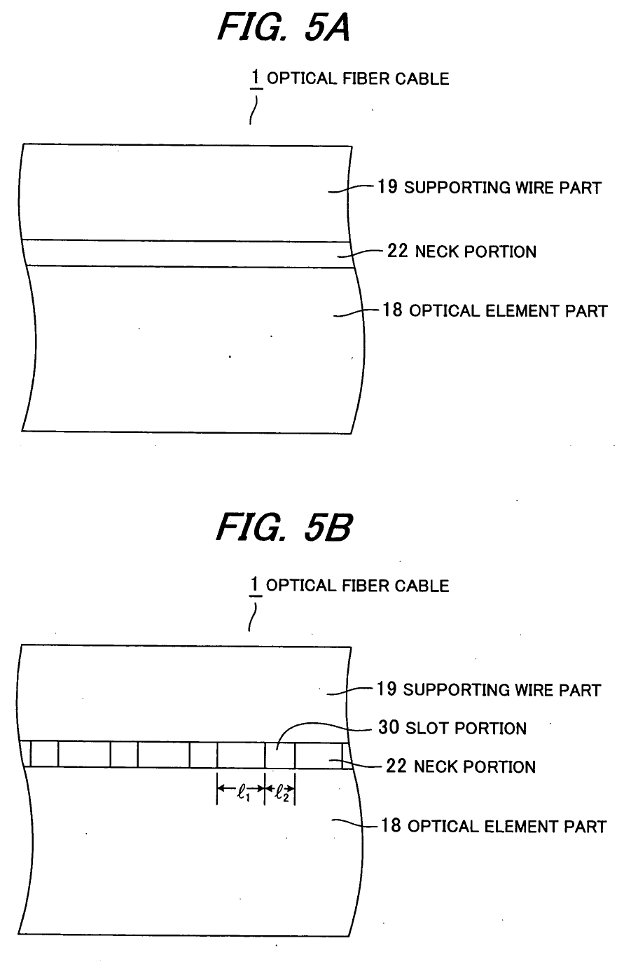

FIGS. 5A and 5B show side views of the optical fiber cable 1 in the embodiment according to the present invention, wherein FIG. 5A is a side view of the optical fiber in which the neck portion 22 is provided continuously and FIG. 5B is a side view of the optical fiber in which the neck portions 22 are provided intermittently. As shown in FIG. 5A, the supporting wire part 19 is connected to the sheath 20 of the optical element part 18 via the neck portion 22 continuously. As shown in FIG. 5B, the supporting wire part 19 may be connected to the sheath 20 via the neck portions 22 intermittently, namely slot portions 30 each having a width 12 are provided between the neck portions 22 each having a width 11.

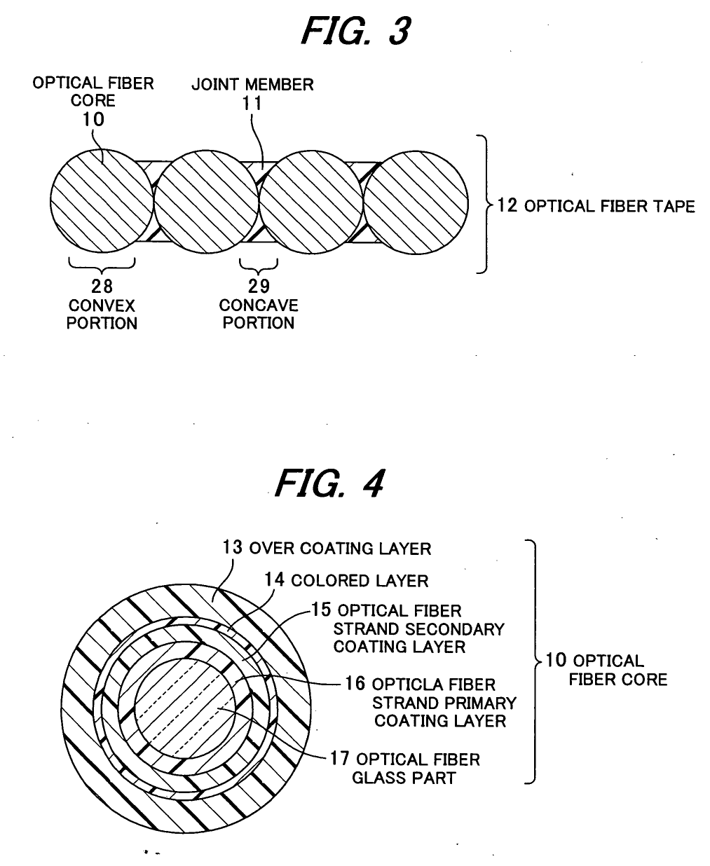

FIG. 3 shows an optical fiber tape 12 used for the optical fiber cable 1 in the preferred embodiment according to the present invention. An optical fiber tape 12 in the preferred embodiment shown in FIG. 3 comprises a plurality of optical fiber cores 10 (the number of optical fiber cores 10 is four in FIG. 3) arranged in parallel with each other and connected with a joint member 11. The joint member 11 is provided such that the concave portion 29 is formed between adjacent optical fiber cores 10. In FIG. 3, the joint member 11 is provided only between the adjacent optical fiber cores 10, however the present invention is not limited thereto. For example, the joint member 11 may be provided to cover an outer periphery of a plurality of the optical fiber cores 10. If the concave portion 29 is formed between the adjacent optical fiber cores 10, the configuration of the optical fiber tape 12 is not limited.

For the optical fiber core 10, as shown in FIG. 2, an optical fiber core with an increased diameter, in which an over coating layer 13 is provided around a colored layer 14 to have an outer diameter of 0.4 mm or more, may be preferably used. Since the optical fiber core with an increased diameter is excellent in operativity, such an optical fiber core is used for the optical fiber cable for installation in the present invention. The optical fiber tape comprising the optical fiber cores with the increased diameter is suitable to produce the optical fiber tape 12 shown in FIG. 3, since a groove between the adjacent optical fiber cores is large.

The optical fiber cable in an embodiment according to the present invention will be described in conjunction with the appended drawings.

In the embodiment, as shown in FIG. 4, an optical fiber core 10 comprises an optical fiber glass part 17 having an outer diameter of about 0.125 mm, an optical fiber strand primary coating layer 16 and an optical fiber strand secondary coating layer 15, each of which is composed of an ultraviolet curing resin for covering the optical fiber glass part 17 to have an outer diameter of about 0.245 mm. In addition, the optical fiber strand secondary coating layer 15 is coated by a colored layer 14 composed of an ultraviolet curing resin to have an outer diameter of about 0.255 mm, and further the colored layer 14 is coated by an over coating layer 13 composed of an ultraviolet curing resin to have an outer diameter of about 0.50 mm.

The optical fiber tape 12 in this embodiment comprises, as shown in FIG. 3, the optical fiber cores 10 that are connected by a joint member 11 composed of an ultraviolet curing resin. As to regard an overall dimension of the optical fiber tape 12, a long diameter is about 2.05 mm and a short diameter is about 0.52 mm.

In the optical fiber cable 1 of this embodiment, as shown in FIG. 4, two pieces of the optical fiber tapes 12 are arranged so that the concave portions 29 and convex portions 28 are engaged with each other. A pair of tensile strength resistant members (tension members) 21, each of which comprises galvanized steel wire having a diameter of 0.4 mm, are disposed along both sides of the optical fiber tapes 12. The optical fiber tapes 12 and tensile strength resistant members 21 are jacketed collectively with a sheath 20 comprising a low-density polyethylene resin, to provide an optical element part 18. A supporting wire 26 comprising a galvanized steel wire with a diameter of 2.3 mm is jacketed with a supporting wire part sheath 23 comprising a low-density polyethylene resin, to provide a supporting wire part 19. The optical element part 18 and the supporting wire part 19 are disposed in parallel with each other and connected with each other by a constricted neck portion 22. In addition, on both of long side faces of the sheath 20, a notch 24 is provided for tearing up the optical fiber cable 1 for taking out the optical fiber tapes 12. A total height of the optical fiber cable 1 is about 7 mm.

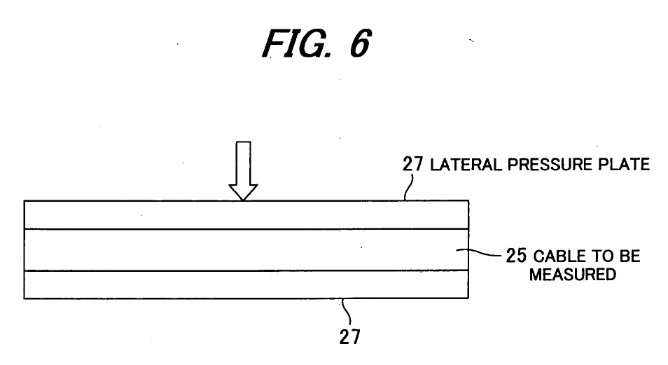

Next, a lateral pressure characteristic evaluation test for an optical fiber cable was carried out. FIG. 6 shows a method of conducting the lateral pressure characteristic evaluation test.

A cable 25 to be measured is sandwiched between lateral pressure boards 27, and a load is applied thereto in a direction indicated by an arrow of FIG. 6. This is a method of evaluating a lateral pressure characteristic of the optical fiber cable by measuring an increasing amount (dB) of an optical loss of the optical fiber with increasing the load (N/100 mm) applied thereto.

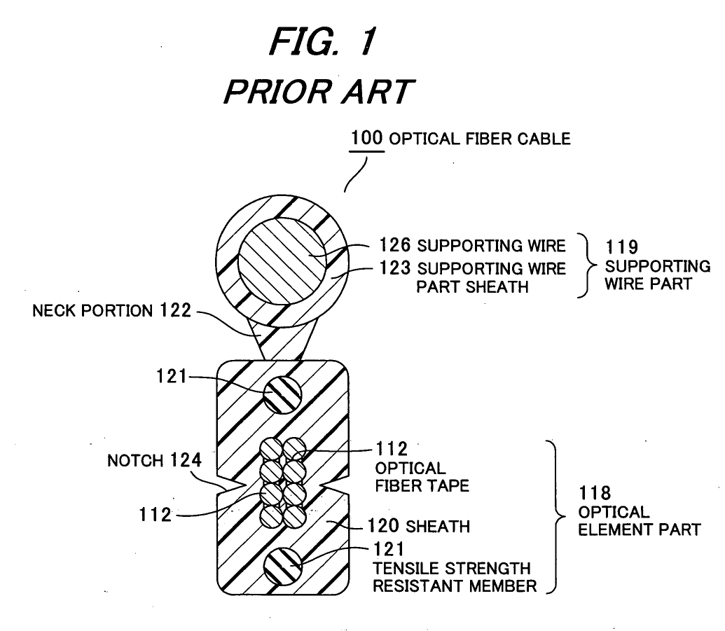

The lateral pressure characteristic evaluation test was conducted by using a conventional optical fiber cable shown in FIG. 1 and an optical fiber cable according to the present invention shown in FIG. 2 as the cable 25 to be measured.

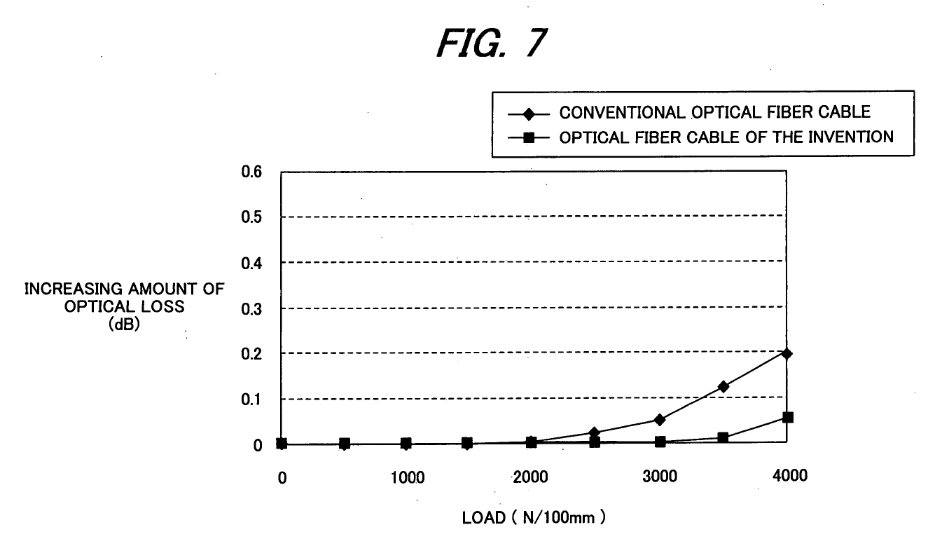

FIG. 7 shows a result of the lateral pressure characteristic evaluation test. As shown in FIG. 7, as for the conventional optical fiber cable, the optical loss is increased under a load of 2500 N/100 mm. As for the optical fiber cable of the present invention, the optical loss is increased under a load of 3500 N/100 mm. As described above, it was confirmed that the optical fiber cable of the present invention is excellent in the lateral pressure resistance characteristic comparing with the conventional optical fiber cable.

Although the invention has been described with respect to specific embodiment for complete and clear disclosure, the appended claims are not to be thus limited but are to be construed as embodying all modification and alternative constructions that may be occurred to one skilled in the art which fairly fall within the basic teaching herein set forth.

What is claimed is:

1. An optical fiber cable, comprising:
an optical fiber tape comprising a plurality of optical fiber cores disposed in parallel and a joint member for connecting a plurality of the optical fiber cores; and
a sheath for accommodating two or more pieces of the optical fiber tapes;
wherein the optical fiber tape is provided with a concave portion between adjacent optical fiber cores and a convex portion, and the two or more pieces of the optical fiber tapes are layered by engaging the concave portion and convex portion.

2. The optical fiber cable, according to claim 1, wherein:
the optical fiber core comprises an optical fiber colored strand having a colored layer as an outermost layer, and an over coating layer formed on the optical fiber colored strand to have an outer diameter of 0.4 mm or more.

3. The optical fiber cable, according to claim 1, wherein:
one or two tensile strength resistant members is accommodated in the sheath.

4. An optical fiber cable, comprising:
an optical fiber tape comprising a plurality of optical fiber cores disposed in parallel and a joint member for connecting a plurality of the optical fiber cores;
a sheath for accommodating two or more pieces of the optical fiber tapes; and
a supporting wire part comprises a supporting wire and a supporting wire part sheath provided on an outer periphery of the supporting wire, and the supporting wire part is connected to the sheath via a neck portion continuously;
wherein the optical fiber tape is provided with a concave portion between adjacent optical fiber cores and a convex portion, and the two or more pieces of the optical fiber tapes are layered by engaging the concave portion and convex portion.

5. The optical fiber cable, according to claim 4, wherein:
the optical fiber core comprises an optical fiber colored strand having a colored layer as an outermost layer, and an over coating layer formed on the optical fiber colored strand to have an outer diameter of 0.4 mm or more.

6. The optical fiber cable, according to claim 4, wherein:
one or two tensile strength resistant members is accommodated in the sheath.

7. An optical fiber cable, comprising:
an optical fiber tape comprising a plurality of optical fiber cores disposed in parallel and a joint member for connecting a plurality of the optical fiber cores;
a sheath for accommodating two or more pieces of the optical fiber tapes; and
a supporting wire part comprises a supporting wire and a supporting wire part sheath provided on an outer periphery of the supporting wire, and the supporting wire part is connected to the sheath via a neck portion intermittently;
wherein the optical fiber tape is provided with a concave portion between adjacent optical fiber cores and a convex portion, and the two or more pieces of the optical fiber tapes are layered by engaging the concave portion and convex portion.

8. The optical fiber cable, according to claim 7, wherein:
the optical fiber core comprises an optical fiber colored strand having a colored layer as an outermost layer, and an over coating layer formed on the optical fiber colored strand to have an outer diameter of 0.4 mm or more.

9. The optical fiber cable, according to claim 7, wherein:
one or two tensile strength resistant members is accommodated in the sheath.
